(19) United States
(12) Patent Application Publication
(10) Pub. No.: US 2003/0105707 A1
(43) Pub. Date: Jun. 5, 2003

(54) Financial risk management system and method

(76) Inventors: Yves Audebert, Los Gatos, CA (US); Jerome Becquart, Fremont, CA (US)

Correspondence Address: STEVENS, DAVIS, MILLER & MOSHER, L.L.P., 1615 L Street, N.W., Suite 850, Washington, DC, 20036, US

(21) Appl. No.: 09/996,576

(22) Filed: Nov. 30, 2001

(51) Int. Cl. G06F 17/60

(52) U.S. Cl. 705/38

(57) ABSTRACT

This invention describes a system and method for reducing financial risk associated with the use of credit and debit cards. The invention provides the ability for a customer to preset spending limits, notification and authorization limits and account suspension limits which a financial services provider uses. Transactions that exceed the customer entered preferences triggers a notification message, authorization request or suspends further transactions from occurring with the customer's account.

### FIELD OF INVENTION

The present invention relates to a data processing method and system for reducing fraudulent financial transactions and provides the ability to authenticate transactions exceeding specified limits.

### BACKGROUND OF INVENTION

Consumers are largely reliant on the financial services industry to validate financial transactions such as credit card charges. However, a fraudulently obtained credit card may be used before the financial services industry and/or the card's owner becomes aware that an unauthorized entity is charging to the credit card. While the financial services industry does have elaborate fraud prevention mechanisms in place, fraud detection usually occurs after one or more initially successful fraudulent transactions. There currently is no mechanism available which alerts the consumer to a potentially fraudulent transaction involving a credit card.

In addition, spending limits are determined by the consumer's credit rating rather than by personal choices made by the consumer. Some card issuers have introduced low spending limit credit cards for use by adolescents. The purported intent of these low spending limits cards is to develop responsible spending habits by early exposure to using credit cards. The basic premise being that exceeding the maximum spending limit prevents further use.

Online financial management systems are known in the art. For example, U.S. Pat. No. 6,131,115 by Anderson, et al. describes an online system for viewing a multitude of customer accounts available from a number of service providers. No provisions are available for the customer to receive transaction notifications or to set transactions limits.

In another approach, U.S. Pat. No. 6,285,991 by Powar describes an interactive bill payment system, which allows a customer to pay bills online to a variety of service providers. Again, no provisions are available for the customer to receive transaction notifications or to set transactions limits.

In another approach, U.S. Pat. No. 6,230,145 by Verderamo, et al., describes a method of providing financial transaction information to a merchant. The system described is oriented for use by a merchant for consolidation of a large number of financial transactions into a statement available over the Internet. Limited interactive capabilities are included, however, the patent does not allow the customer to receive transaction notifications or to set transactions limits and is intended for a merchant rather than a consumer.

In yet another approach, U.S. Pat. No. 5,590,197 by Chen, et al. describes an online bill payment system, which incorporates the use of an electronic purse or wallet for conducting E-commerce transactions. Again, no provisions are available for the customer to receive transaction notifications, set transaction limits or to authorize transactions exceeding a predetermined amount.

Thus it is apparent that a system which allows a customer to set transaction limits and provides notifications of transactions, allows authorization of transaction and performs account suspensions when transactions exceed authorized limits is highly desirable.

### BRIEF SUMMARY OF THE INVENTION

This invention describes a web-based system that allows a customer to enter preset spending limits and includes telecommunications information that provides notification to the customer when the preset spending limits are being exceeded. A second feature of this invention provides the ability to authorize transactions, which exceed the preset spending limits thus providing even greater control of a consumer's credit transactions. A third feature of this invention provides account suspension if spending exceeds, preset spending limits either in a single transaction or cumulatively over a pre-established period of time.

Robust authentication procedures should be established to ensure that only the customer is permitted access to his or her account. Common procedures including entry of an account number, user name and password, PIN (Personal Identity Number) entry, authentication token, biometric entry, and digital certificate exchange should be sufficient for accessing the customer's account and entering the notification and transaction information.

The transaction notification methods may include sending an email to an entered email address, calling a designated phone number (either POTS or cellular), interactive television (set top box) or calling a pager number. A further enhancement includes the ability to approve pending transactions; for example, an SMS (Short Messsage Service) message may request that a user formally authenticate the transaction using pre-established cryptographic methods etc. Other methods may request the user to call a telephone number that prompts the user for a PIN or other alphanumeric sequence in order to authorize the transaction.

Account suspension features allow the customer's account to be blocked from further use if pre-established transaction limits are exceeded. This feature includes sending notification of the account's suspended status to the customer using one or more of the notification methods described above. The suspended account requires the customer to contact his or her financial institution in order to reactivate the account.

### BRIEF DESCRIPTION OF THE DRAWINGS

A more complete understanding of the present invention may be accomplished by referring to the following Detailed Description and claims, when viewed in conjunction with the following drawings:

FIG. 1 is a block diagram providing an overview of the notifications and authorization systems available for implementing the invention.

FIG. 2 is a flow chart for establishing the cardholder's preferences.

FIG. 3 depicts a simulated web data entry screen for establishing the cardholder's preferences.

FIG. 4 is a flow chart for evaluating transactions by a financial institution.

### DETAILED DESCRIPTION OF THE INVENTION

This patent describes a new procedure, which allows a customer to approve financial service transactions based on preset spending limits. When a single or cumulative number of transactions exceed a preset limit, notifications are sent to one or more devices prearranged by the customer. This allows a customer to monitor expenditures and control spending habits. Another benefit of this patent is the ability to detect fraudulent transactions. Since the customer presumably is aware of the usage of his or her account, unauthorized transactions, which exceed the pre-established transaction limits, will alert the customer to fraudulent transactions that are occurring generally before the financial institution becomes aware that the customer's account has been compromised.

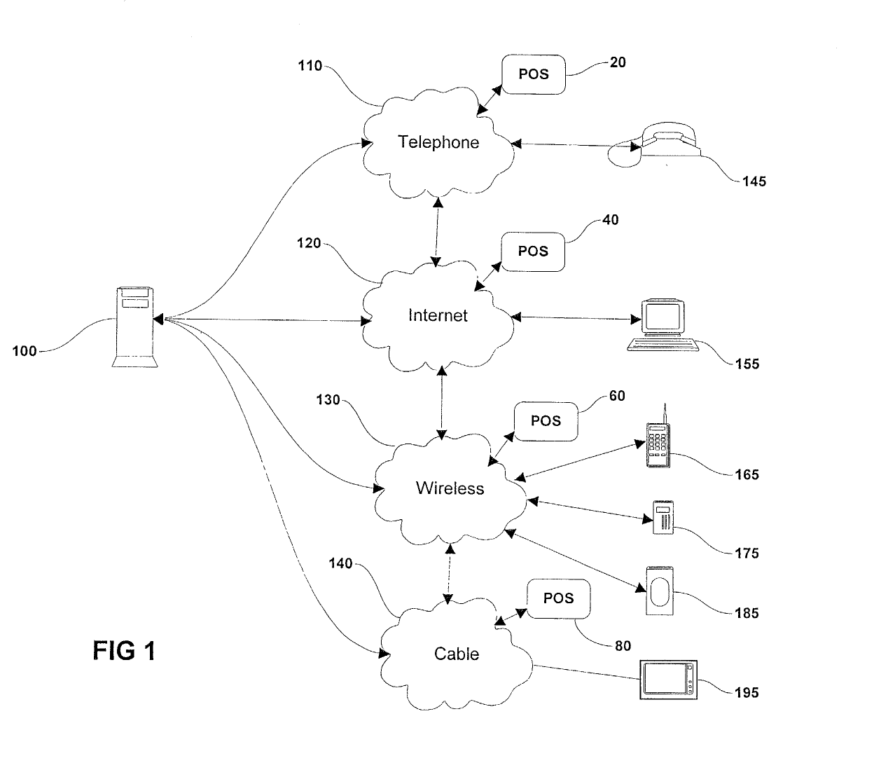

Referring to FIG. 1, a generalized diagram is shown which includes the various network interactions and notification devices available. In FIG. 1, a financial services server 100 is interconnected with a plurality of telecommunications networks including the public telephone system network 110, the Internet 120, wireless network 130 and cable television network 140.

A customer has the option of including transaction notification devices such as a normal telephone 145, email messages to a web enabled computer 155, cellular telephone 165, pager 175 personal data assistant (PDA) 185 or television set 195. Point of sales (POS) terminals 20, 40, 60, 80 may be connected on one or more of the plurality of networks, which perform financial transactions with the financial services server 100.

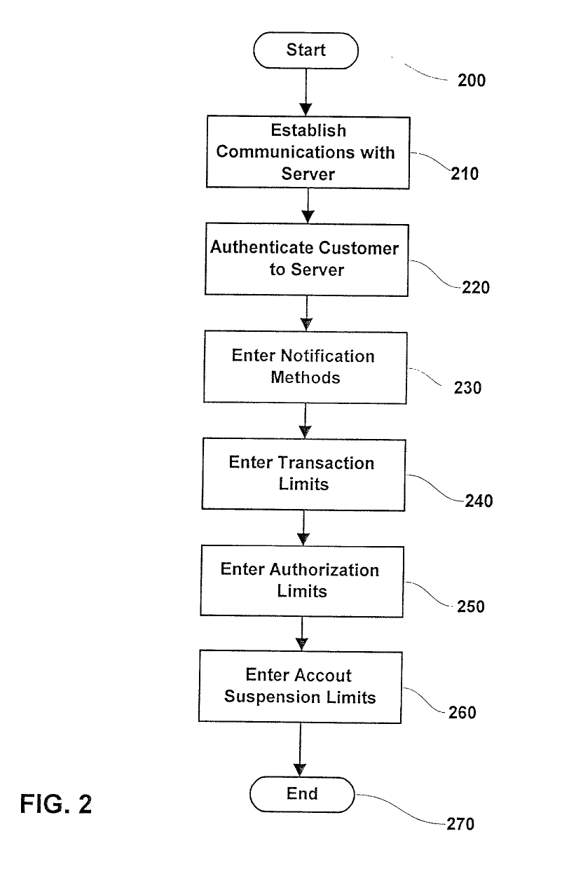

Referring to FIG. 2, a current customer at a local client initiates 200 a connection with a financial services server. Once a connection is established 210 between the client (customer) and the financial services server, the customer is authenticated 220 using a preferably robust authentication mechanism: examples include entry of an account number, user name and password, PIN entry, authentication token, biometric entry, and digital certificate exchange. Robust authentication methods are well known in the art and will not be described further. In the preferred embodiment of the invention, secure communications are maintained between the client and the financial services server. High-level encryption methods such as SSL, IPSEC, etc., using at least 128-bit encryption should be employed.

Once the customer is properly authenticated 220, the customer is allowed access to the data input screen which allows entry of the customer's preferences related to notification methods 230, transaction limits 240, authorization limits 250 and account suspension limits 260. After the customer has completed entry of the information processing is ended 270.

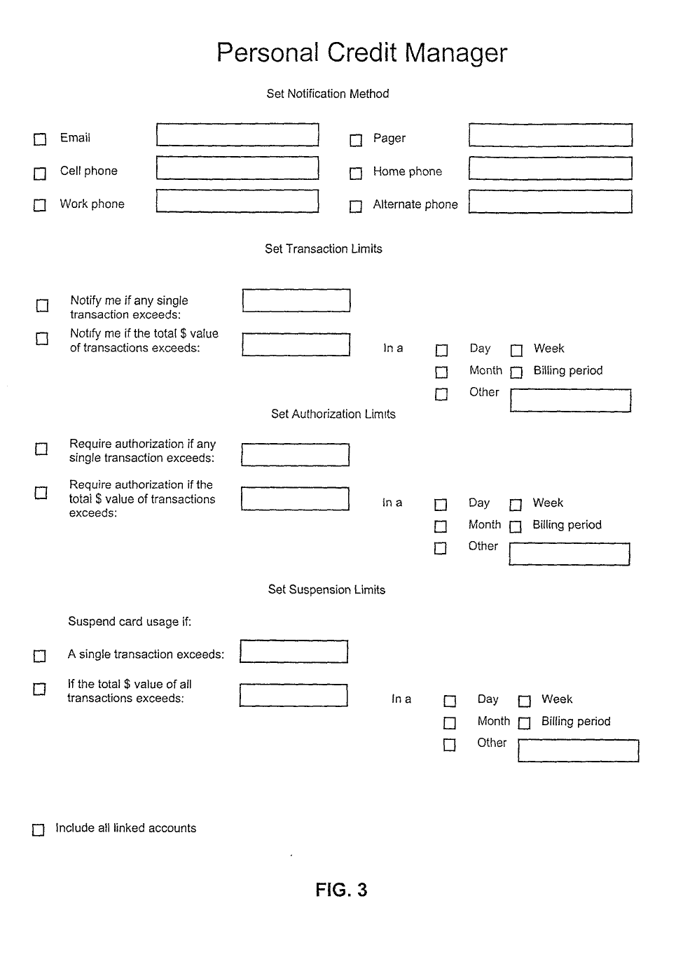

Referring to FIG. 3, an example screen which illustrates the data entry blocks for the various notification methods, transaction limits, authorization limits and account suspension limits. Optionally, the customer has the ability to utilize the entered information for all accounts linked to his or her current account. The customer input screen may be programmed in any common language such as HTML, XML, XHTML, etc.

Notification methods includes the ability to send email to a specified email address, call a cellular telephone number, call a work phone number, call a digital pager, call a home number or call an alternative number. The notification methods that allow return of a response may also be used to perform authorizations.

The notification transaction limits includes the ability to specify single transaction and/or cumulative transaction levels which when exceeded will cause notifications to be issued using the customer notification method(s) selected above. Cumulative transaction limits may be specified over an appropriate period of time including transactions occurring daily, weekly, monthly, per billing period or a customer specified period (e.g. quarterly.)

The authentication transaction limits includes the ability to specify single transaction and/or cumulative transaction levels which when exceeded will require authorization to be received following issuance of a notification message as described above. The authorization may include entry of a PIN, biometric result, and user name/password, etc. which is returned to the customer notification method(s) selected above. Again, cumulative transaction limits may be specified over an appropriate period of time including transactions occurring daily, weekly, monthly, per billing period or a customer specified period (e.g. quarterly.)

The account suspension transaction limits includes the ability to specify single transaction and/or cumulative transaction levels which when exceeded will suspend the customer's account from receiving any further financial transactions until reset by the financial institution in accordance with their internal policies. As before, cumulative transaction limits may be specified over an appropriate period of time including transactions occurring daily, weekly, monthly, per billing period or a customer specified period (e.g. quarterly.)

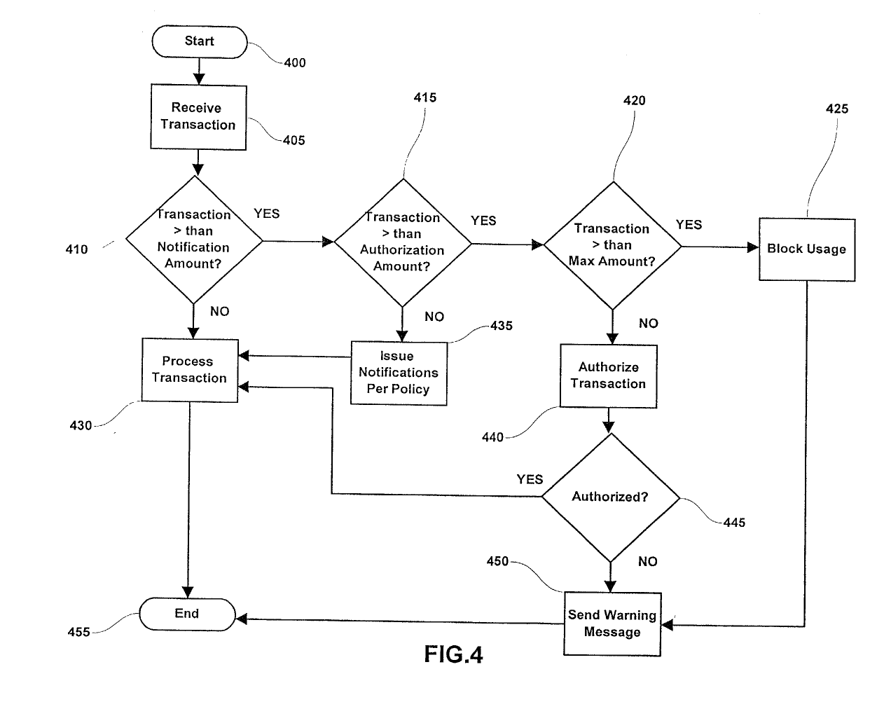

Referring to FIG. 4, a flow chart depicts the financial institution's processing of financial transactions received from one or more point of sale terminals. Processing is initiated 400 by receipt of a financial transaction 405 associated with a customer's account number by the financial services server. The transaction amount is compared with the preset notification limits. If the transaction amount is below the preset notification limits, the transaction is processed 430 without performing notifications and processing ends 455 for this transaction.

If the transaction amount is greater than the preset notifications limits, the transaction is compared with the authorization limits 415. If the transaction amount is below the preset authorization limits, notifications are issued 435, the transaction is processed 430 and processing ends 455 for this transaction.

If the transaction amount is greater than the preset authorization limits, the transaction is compared with the account suspension limits 420. If the transaction amount is below the preset account suspension limits, authorization 440 is required using the preset notification methods. If a proper authorization is received 445, the transaction is processed 430 and processing ends 455 for this transaction. If no authorization or an invalid authorization is received, a warning message is sent 450 to the preset notification methods and processing ends 455 for this transaction.

Lastly, if the transaction amount is greater than the preset account suspension limits, the customer's account is blocked 425 from further use, a warning message is sent 450 using the preset notification methods and processing ends 455 for this transaction.

The foregoing described embodiments of the invention are provided as illustrations and descriptions. They are not intended to limit the invention to precise form described. In particular, it is contemplated that functional implementation of the invention described herein may be implemented equivalently in hardware, software, firmware, and/or other available functional components or building blocks. Other variations and embodiments are possible in light of above teachings, and it is not intended that this Detailed Description limit the scope of invention, but rather by the claims following herein.

What is claimed:

1. A network enabled online transaction risk management system comprising;
at least one financial services server for processing financial transaction requests received over said network for at least one customer account wherein preferences for said at least one customer account are remotely configurable over said network;
at least one client in processing communications with said at least one financial services server over said network including means for remote configuration of said at least one customer account using one or more customer preferences;
at least one point of sales terminal in processing communications with said at least one financial services server including means for performing financial transactions with said financial services server.

2. The system according to claim 1 wherein said one or more customer preferences includes notification methods and said system comprises notification means for performing said notification methods.

3. The system according to claim 2 wherein said notification methods further includes authorization methods and said system further comprises authorization means for performing said authorization methods.

4. The system according to claim 3 wherein said one or more customer preferences includes transaction limits.

5. The system according to claim 4 wherein said one or more customer preferences includes authorization limits.

6. The system according to claim 5 wherein said one or more customer preferences includes account suspension limits.

7. The system according to claim 6 wherein said one or more customer preferences includes single transactions.

8. The system according to claim 7 wherein said one or more customer preferences includes cumulative transactions.

9. The system according to claim 8 wherein said one or more customer preferences includes an applicable time period.

10. The system according to claim 1 wherein said at least one financial services server authenticates said at least one customer before allowing said at least one customer access to said at least one customer account.

11. The system according to claim 1 wherein said communications is performed using a secure messaging protocol.

12. The system according to claim 1 wherein said network includes the Internet.

13. The system according to claim 1 wherein said network includes a public telephone service network.

14. The system according to claim 1 wherein said network includes a cellular telephone network.

15. The system according to claim 1 wherein said network includes a cable television network.

16. The system according to claim 2 wherein said notification means includes a cellular telephone.

17. The system according to claim 2 wherein said notification means includes a pager.

18. The system according to claim 2 wherein said notification means includes a regular telephone.

19. The system according to claim 2 wherein said notification means includes electronic mail.

20. The system according to claim 2 wherein said notification means includes a personal data assistant.

21. The system according to claim 2 wherein said notification means includes a television equipped with a set top box.

22. The system according to claim 9 further including comparator means wherein said comparator means compares financial transactions received from said at least one point of sales terminal to said one or more customer preferences.

23. The system according to claim 22 wherein notifications are sent to said at least one customer using said notification means if said financial transactions exceeds said one or more customer preferences.

24. The system according to claim 23 wherein authorization requests are sent to said at least one customer using said notification means if said financial transactions exceeds said one or more customer preferences.

25. The system according to claim 24 wherein said at least one customer account belonging to said at least one customer is suspended if said financial transactions exceeds said one or more customer preferences.

26. A method for reducing financial transaction risk comprising;
establishing networking communications between a client and a financial services server by at least one customer wherein said financial services server is in processing communications with at least one point of sales terminal,
accessing an account on said financial services server owned by said at least one customer,
entering one or more customer preferences,
comparing financial transactions received from said at least one point of sales terminal to said one or more customer transactions,
sending notifications to said at least one customer if said financial transactions exceed said one or more customer preferences,
requesting authorization of said at least one customer if said financial transactions exceed said one or more customer preferences,
suspending further financial transactions of said at least one customer if said financial transactions exceed one or more customer preferences.

27. The method according to claim 26 further including the step of authenticating said customer to said financial services server.

28. The method according to claim 26 wherein said networking communications includes using the Internet.

29. The method according to claim 26 wherein said networking communications includes using a public telephone service network.

30. The method according to claim 26 wherein said networking communications includes using a cellular telephone network.

31. The method according to claim 26 wherein said networking communications includes using a cable television network.

32. The method according to claim 26 wherein said one or more customer preferences includes transaction limits.

33. The method according to claim 26 wherein said one or more customer preferences includes authorization limits.

34. The method according to claim 26 wherein said one or more customer preferences includes account suspension limits.

35. The method according to claim 26 wherein said one or more customer preferences includes single transactions.

36. The method according to claim 26 wherein said one or more customer preferences includes cumulative transactions.

37. The method according to claim 26 wherein said one or more customer preferences includes an applicable time period.

38. The method according to claim 26 wherein said notification methods includes a cellular telephone.

39. The method according to claim 26 wherein said notification methods includes a pager.

40. The method according to claim 26 wherein said notification methods includes a regular telephone.

41. The method according to claim 26 wherein said notification methods includes electronic mail.

42. The method according to claim 26 wherein said notification methods includes a personal data assistant.

43. The method according to claim 26 wherein said notification methods includes a television equipped with a set top box.
